(19) United States
(12) Patent Application Publication
(10) Pub. No.: US 2024/0060417 A1
(43) Pub. Date: Feb. 22, 2024

(54) OIL FIELD TRACER, METHOD FOR OIL FIELD TRACING, AND PROPPANT COMPOSITION

(71) Applicant: SUZHOU XINGSHUO NANOTECH CO., LTD., Suzhou, Jiangsu (CN)

(72) Inventor: Yunjun WANG, Suzhou, Jiangsu (CN)

(21) Appl. No.: 18/270,503

(22) PCT Filed: Dec. 18, 2020
(86) PCT No.: PCT/CN2020/137773

§ 371 Date: Jun. 30, 2023

(30) Foreign Application Priority Data
Dec. 31, 2019 (CN) 201911411302.7

(51) Int. Cl. E21B 49/00; C09K 8/80; E21B 49/08; G01N 21/64

(52) U.S. Cl. CPC E21B 49/008; C09K 8/805; E21B 49/088; E21B 49/0875; G01N 21/64; C09K 2208/10

(57) ABSTRACT

Disclosed are an oil field tracer, a method for oil field tracing, and a proppant composition. An oil field tracer having both magnetic and fluorescent functions is used, and can be enriched with a magnetic field when a producing well is sampled for testing.

### CROSS-REFERENCES TO RELATED APPLICATION

The present application is a National Stage of International Patent Application No. PCT/CN2020/137773, filed on Dec. 18, 2020, and claims the benefit of the priority of the Chinese patent application with the application CN201911411302.7, filed to the China National Intellectual Property Administration on Dec. 31, 2019, the entire content of which is incorporated in this application by reference.

### TECHNICAL FIELD

The present application relates to the field of oil field chemical additives, in particular to an oil field tracer, a method for oil field tracing, and a proppant composition.

### BACKGROUND

Oil field tracing technology is one of the on-site production testing technologies. The technology is to inject a tracer into an injection well, then take samples from the surrounding withdrawal wells according to certain sampling regulations, and monitor the change of the tracer over time, which can guide the design of the oil well drilling and the adjustment in the later stage of the oil field development. An oil field tracer can qualitatively describe the oil reservoir conditions, such as the advancing direction and speed of the injected fluid, evaluation of volumetric sweep efficiency, fluid shielding, directional flow trend, heterogeneity characteristics of oil reservoir, determination of remainder oil saturation and distribution, etc.

For a long time, there are three kinds of tracers commonly used in the oil fields: a chemical tracer, an isotope tracer and a micro-matter tracer. For example, the chemical tracer includes a soluble inorganic salt, a fluorescent dye, a halogenated hydrocarbon and an alcohol with low relative molecular weight. The isotope tracers include a radioisotope tracer and a stable isotope tracer. Such tracers have different degrees of disadvantages: large usage amount of chemical tracers, high cost and large detection error; the isotope tracer must be detected by professional construction personnels with special-purpose equipment, which is not conducive to large-scale popularization and application; and the micro-matter tracer needs to be detected by high-end analytical equipment, such as inductively coupled plasma mass spectrometry, etc.

Fluorescence detection technology has the advantages of high detection sensitivity, simple operation, low cost and adjustable detection range, etc. The fluorescence signals can be detected quickly, simply and with high sensitivity by a fluorescence spectrophotometer, which can be used in the field of oil field tracing. However, suitable fluorescent tracers must be found during the implementation of this technology, such as those having characteristics of good optical stability, strong fluorescence, low background concentration in the formation, less adsorption on the formation surface, no reaction with formation minerals, easy detection, and high sensitivity, etc.

Among the existing fluorescent tracers, the most common tracers include: fluorescent dyes, but they have the disadvantages of short period of validity, ease of being disturbed, large formation adsorption consumption, etc.; and fluorescent polymers. Fluorescent polymer is prepared by copolymerizing a fluorescent monomer (e.g., a fluorescent dye or derivatives thereof) with some water-soluble monomers, or reacting a fluorescent dye with a water-soluble polymer and derivatives thereof. For example, in CN110054728A, the embedded tracing polymeric microsphere emulsion is prepared by using allyl fluorescein monomer, acrylamide and 2-acrylamide-2-methylpropanesulfonic acid, although it has good stability, the fluorescence of such fluorescent polymers is weak, which is not conducive to detection.

In addition, there is still a problem in the use of the existing common fluorescent tracers. For example, when the sampling of the withdrawal well is conducted for detection, the concentration of the fluorescent tracers in the fluid to be detected is low, the further enrichment of the fluorescent tracers is very difficult or the method thereof is complex, which will eventually lead to large detection error.

### SUMMARY

In view of the above technical problems, the present application provides an oil field tracer, a method for oil field tracing, and a proppant composition, so as to provide a novel oil field tracer.

According to one aspect of the present application, there is provided an oil field tracer having magnetism and fluorescence.

According to one aspect of the present application, there is provided an oil field tracer including a magnetic material and a fluorescent material.

In one embodiment, the magnetic material includes: a metal and a metal oxide having superparamagnetism, paramagnetism or ferromagnetism.

In one embodiment, the fluorescent material includes at least one of fluorescent nanoparticles, fluoresceins, fluorescent polymers and organic fluorescent molecules.

In one embodiment, the fluorescent nanoparticle includes quantum dots, nanorods and nanosheets.

In one embodiment, the oil field tracer includes magnetic fluorescent microspheres.

In one embodiment, the magnetic fluorescent microsphere includes a magnetic material and a fluorescent material.

According to another aspect of the present application, there is provided a method for oil field tracing, including the following steps:
injecting a fluid including an oil field tracer into an injection well, wherein the oil field tracer has magnetism and fluorescence; obtaining the sample to be tested at the withdrawal well; and analyzing the sample to be tested so as to determine whether the oil field tracer is present therein.

According to another aspect of the present application, there is provided a method for oil field tracing, including the process of magnetic enrichment and fluorescence detection of the oil field tracer.

According to another aspect of the present application, there is provided a proppant composition, it includes proppant particulates and the oil field tracer as described above.

The present application has the following beneficial effects:
(1) a new type of fluorescent tracer is provided by using an oil field tracer with dual functions of magnetism and fluorescence;
(2) when the sampling of the withdrawal well is conducted for detection, magnetic field can be used to enrich the oil field tracer. Compared with the direct detection of stock solution, the error of enriching and then analyzing and testing the oil field tracer is significantly decreased;
(3) quantum dot is a kind of nano-luminescent material, on which the structural improvement and surface modification are easy to be carried out, moreover it has good stability, high fluorescence luminescence efficiency, and the emission wavelength thereof is easy to control, which just meets the requirements of oil field tracers for high stability and strong fluorescence signals.

### BRIEF DESCRIPTION OF THE DRAWINGS

The accompanying drawings, which form a part of the present application, are used to provide further understanding of the present application, the illustrative embodiments of the present application and the description thereof are intended to explain the present application and are not intended to limit thereto inappropriately. In the drawings:

FIG. 1 is a structural diagram of a magnetic fluorescent microsphere according to one embodiment of the present application;

FIG. 2 is a structural diagram of a magnetic fluorescent microsphere according to one embodiment of the present application;

FIG. 3 is a structural diagram of a magnetic fluorescent microsphere according to one embodiment of the present application;

FIG. 4 is a structural diagram of a magnetic fluorescent microsphere according to one embodiment of the present application;

FIG. 5 is a structural diagram of a magnetic fluorescent microsphere according to one embodiment of the present application;

FIG. 6 is a schematic diagram of tracing using magnetic fluorescent microspheres combined with proppant particulates;

FIG. 7 is a schematic diagram of the combination of proppant particulates and magnetic fluorescent microspheres according to one embodiment;

FIG. 8 is a schematic diagram of the combination of proppant particulates and magnetic fluorescent microspheres according to one embodiment;

FIG. 9 is a photograph of the solution of the magnetic fluorescent microspheres in ethanol in a UV box according to Example 1;

FIG. 10 is a fluorescence emission spectrum of the magnetic fluorescent microsphere according to Example 1;

FIG. 11 is a photograph of the enrichment of the magnetic fluorescent microspheres under a magnetic field according to Example 1;

FIG. 12 is a fluorescence emission spectrum of the crude oil according to one embodiment of the present application; and

FIG. 13 is a comparison diagram of fluorescence emission peaks of the crude oil and the magnetic fluorescent microspheres according to one embodiment of the present application.

In the drawings, the same reference numerals are used for the same parts. The drawings only schematically show the embodiments of the present application.

### DETAILED DESCRIPTION OF THE EMBODIMENTS

The technical solutions in the examples of the present application will be described in detail below in combination with the embodiments of the present application. It should be noted that the described embodiments are only part of the embodiments of the application, not all of the embodiments.

The terms as used herein are only intended for the purpose of describing specific embodiments rather than restricting. If not otherwise defined, all terms including technical and scientific terms in the specification can be defined as generally understood by those skilled in the art. Terms defined in common dictionaries shall be interpreted as having meanings consistent with their meanings in the context of the relevant fields and in the present disclosure, and may not be interpreted in an ideal manner or too broadly unless clearly defined. In addition, unless expressly described to the contrary, the words “comprise” and “include” when used in this specification indicate the existence of the stated features, regions, whole, steps, operations, elements, and/or components, but do not exclude the existence or addition of one or more other features, regions, whole, steps, operations, elements, components, and/or combinations thereof. Therefore, the above words will be understood to mean that the stated elements are included, but any other elements are not excluded.

It will be understood that although the terms “first”, “second”, and “third”, etc. may be used herein to describe various elements, components, regions, layers and/or parts, these elements, components, regions, layers and/or parts shall not be limited by these terms. These terms are used only to distinguish one element, component, region, layer or part from another element, component, region, layer or part. Therefore, without departing from the teaching of the present embodiment, the first element, component, region, layer or part discussed below can be referred to as the second element, component, region, layer or part.

The following definitions apply to some aspects described with respect to some embodiments of the present application, which can also be extended herein.

As used herein, the singular forms “an” and “the” include multiple references unless the context clearly dictates otherwise. A reference to an object may include multiple objects unless the context clearly dictates otherwise.

As used herein, the term “adjacent” refers to close to or adjoining. Adjacent objects can be separated from each other, or they can actually or directly contact with each other. In some cases, adjacent objects may be connected to each other or may be formed with each other as a whole.

As used herein, the term “connection” refers to an operational coupling or link. Linked objects can be directly coupled to each other or indirectly coupled to each other via another set of objects.

As used herein, relative terms such as “interior”, “inside”, “exterior”, “outside”, “top”, “bottom”, “front”, “back”, “rear”, “upper”, “lower”, “vertical”, “transverse”, “above” and “below” refer to, for example, the orientation of a group of objects to each other according to the attached drawings, but the specific orientation of these objects is not required during manufacture or use.

An embodiment of the present application provides an oil field tracer with magnetism and fluorescence. Magnetism means that the oil field tracer has obvious magnetic guidance under the action of appropriate magnetic field intensity. For example, after dispersing the oil field tracer in a medium, under the action of the magnetic field, the oil field tracer will move along the direction of the magnetic field and gather in a certain direction, thereby separating from the medium. The fluorescence characteristic means that the magnetic fluorescent microsphere emits the emergent light with a wavelength that is inconsistent with the wavelength of the incident light after being irradiated by the incident light of a certain wavelength.

The oil field tracer provided in one embodiment of the present application includes a magnetic material and a fluorescent material. In this way, the oil field tracer has the dual functions of magnetism and fluorescence.

Magnetic material includes but is not limited to: a metal and a metal oxide having superparamagnetism, paramagnetism or ferromagnetism. For example, it includes but is not limited to Fe₃O₄, Fe₂O₃, CoFe₂O₄, MnFe₂O₄, NiFe₂O₄, compound neodymium iron boron, samarium cobalt, metals Fe, Co, Ni or metal oxides of alloys Fe₂Co, Ni₂Fe, etc.

Fluorescent material includes but is not limited to: at least one of fluorescent nanoparticles, fluoresceins, fluorescent polymers or organic fluorescent molecules. Among them, the fluorescent nanoparticle includes quantum dots, nanorods and nanosheets. Among them, quantum dots can also be called “light conversion nanoparticles” or “luminescent nanoparticles”, etc. Individual quantum dot is spherical as a whole. Quantum dots are roughly the same size in three dimensions, and the size (the distance between the farthest two points of quantum dots) can be between 1 and 20 nanometers. The excellent characteristics of quantum dots include high fluorescence quantum yield, that is, when absorbing the same number of incident light photons, they can produce more emergent light photons, emit brighter light, and the half peak width of the fluorescence emission peak of quantum dots is small. The materials of which the quantum dots are constituted generally include Group IIB-VIA, Group IIIA-VA, Group IVA-VIA, Group IVA, Group IB-IIIA-VIA, Group VIII-VIA, or perovskite materials, etc. These materials refer to the luminescent center of the quantum dots, which specifically can be ZnO, ZnS, ZnSe, ZnTe, CdS, CdSe, CdTe, MgS, MgSe, GaAs, GaN, GaP, GaSe, GaSb, HgO, HgS, HgSe, HgTe, InAs, InN, InP, InGaP, InSb, AlAs, AlN, A1P, AlSb, TlN, TlP, TlAs, TlSb, PbS, PbSe, PbTe, Si, C, etc., or an alloy comprising any of the foregoing substances and/or a mixture comprising any of the foregoing substances, including a ternary and quaternary mixture or an alloy.

Quantum dots generally include core and shell, the core includes a first semiconductor material, and the shell includes a second semiconductor material, wherein the shell is arranged on at least a part of the surface of the core. Semiconductor nanocrystals including core and shell are also called “core/shell” quantum dots. Any of the materials indicated above can be particularly used as core.

The shell may be a semiconductor material having the same or different components as the core. The shell includes a housing of semiconductor material on the surface of the core. The shell can include one or more layers. The shell includes at least one semiconductor material with the same or different components as the core. Preferably, the thickness of the shell is from about 1 to about 30 monolayers, and the shell material can have a band gap greater than that of the core material. In some other embodiments, the surrounding shell material can have a band gap smaller than that of the core material. For example, “core/shell” quantum dots can be InP/ZnS, InGaP/ZnS, and CdSe/ZnS, etc.

Environmentally friendly quantum dots generally do not include heavy metals. Environmentally friendly quantum dots can be carbon quantum dots, silicon quantum dots, lead-free perovskite quantum dots, indium phosphide quantum dots, etc. By way of carbon quantum dots as an example, the main constituent elements of carbon quantum dots are carbon, hydrogen, and also possibly some oxygen, nitrogen, etc., and the internal composition thereof is basically amorphous structure, which has the advantage of no potential damage to the environment.

Fluorescein includes but is not limited to stilbenes, coumarins, fluoranes (xanthenes), benzoxazoles (including imidazoles and thiazoles), naphthalimides, thiophene dicarboxylic acid amides, fused-ring aromatics (fluoranthene), perylene tetraformylimines, phycoerythrin, orperidinin chlorophyll proteins, etc.

In an embodiment of the present application, an oil field tracer including magnetic fluorescent microspheres is provided. As a whole, the magnetic fluorescent microspheres are spherical and have roughly the same size in three dimensions. The three-dimensional sizes of the microspheres are about 0.05 to 20 microns. Generally, the three-dimensional size of magnetic fluorescent microspheres is preferably less than 2 microns, which can effectively reduce the precipitation and aggregation of magnetic fluorescent microspheres.

Magnetic fluorescent microspheres have the dual functions of magnetism and fluorescence. Magnetism means that the magnetic fluorescent microspheres have obvious magnetic guidance under the action of appropriate magnetic field intensity. For example, after dispersing the magnetic fluorescent microspheres in a medium, under the action of the magnetic field, the magnetic fluorescent microspheres will move along the direction of the magnetic field and gather in a certain direction, thereby separating from the medium. Common magnetic materials that can produce appropriate magnetic field include but are not limited to neodymium iron boron magnet, samarium cobalt magnet, aluminum nickel cobalt magnet, or ferrite magnet, etc. The fluorescence characteristic means that the magnetic fluorescent microsphere emits the emergent light with a wavelength that is inconsistent with the wavelength of the incident light after being irradiated by the incident light of a certain wavelength. The emergent light generally has a wavelength larger than that of the incident light. The wavelength of light suitable for exciting magnetic fluorescent microspheres is preferably between 200 and 800 nanometers, more preferably between 300 and 500 nanometers. Common fluorescence-emitting substances include organic fluorescent micromolecules, fluorescent polymers, fluorescent nanomaterials, etc.

In the application of the magnetic fluorescent microspheres in oil field tracers, an oil-soluble tracer, or a water-soluble tracer or yet an oil-water distribution tracer can be designed as required. Common design methods include hydrophilic and hydrophobic modification of the surface of magnetic fluorescent microspheres, or selection of hydrophilic and hydrophobic materials in microspheres, etc. When sampling the withdrawal well, a mixture containing oil and water is generally obtained. When an oil-soluble tracer is used, the tracer is mainly dispersed in the oil, and the tracer in the oil is the main detection object. Similarly, when a water-soluble tracer is used, the tracer is mainly dispersed in water, and the tracer in water is the main detection object.

The magnetic fluorescent microspheres can include magnetic nanoparticles, quantum dots, and polymers or inorganics. Nanoparticles, quantum dots and polymers or inorganics are combined to form microspheres. In this case, the magnetism of the magnetic fluorescent microspheres originates from magnetic nanoparticles. Magnetic nanoparticles are metals and metal oxides having superparamagnetism, paramagnetism or ferromagnetism, for example, Fe₃O₄, Fe₂O₃, CoFe₂O₄, MnFe₂O₄, NiFe₂O₄, compound neodymium iron boron, samarium cobalt, metals Fe, Co, Ni or metal oxides of alloys Fe₂Co, Ni₂Fe, etc. Polymers or inorganics can be used as carriers of nanoparticles and quantum dots, and temperature, pH value and salt concentration, etc. of underground oil field all put forward high requirements for the stability of the magnetic fluorescent microspheres, and polymers or inorganics in turn can be used as protective agents for both nanoparticles and quantum dots.

Among them, the polymer is generally used as the carrier of nanoparticles and quantum dots. The polymer can be any polymer, such as linear polymer, hyperbranched polymer, cross-linked polymer, star polymer, dendrimer, random copolymer, alternating copolymer, graft copolymer, block copolymer and terpolymer. Polymers include but are not limited to polyethylene, polypropylene, polystyrene, polyoxyethylene, polysiloxane, polyphenylene, polythiophene, poly(phenylene ethylene), polysilane, polyethylene terephthalate and poly (phenylethynyl), polymethylmethacrylate, polylaurylisobutyrate, polycarbonate and epoxy resin, etc. Due to its good barrier properties against water and oxygen, etc., inorganics can generally be used as protective materials for nanoparticles and quantum dots. Inorganics include but are not limited to silicon-containing oxide, aluminium-containing oxide, zirconium-containing oxide, glass, titanium-containing oxide, hafnium-containing oxide or yttrium-containing oxide, etc., specifically such as silica, titanium dioxide, etc.

When the quantum dots are combined with the polymers, they can be dispersed in the polymers. In this case, after mixing the quantum dots with the polymer precursors, the quantum dots can be embedded in the polymers in the process of preparing the polymers; alternatively, after the polymer is swelled by swelling, making the quantum dots enter the swelling pores of the polymers; alternatively, after the polymers containing porous structure are prepared, for example, the polymers containing porous structure can be polymer microspheres, and then the quantum dots are encapsulated in these pores; alternatively, there are connecting substances between quantum dots and polymers, for example, chemical crosslinking or intermolecular force is adopted to modify the quantum dots on the polymers.

The combination of polymers and magnetic nanoparticles is roughly in a similar way to the combination of polymers and quantum dots. Magnetic nanoparticles can be dispersed in the polymers, or can be embedded in the pores of porous combined polymers, or can be modified on the polymers by chemical crosslinking or intermolecular force.

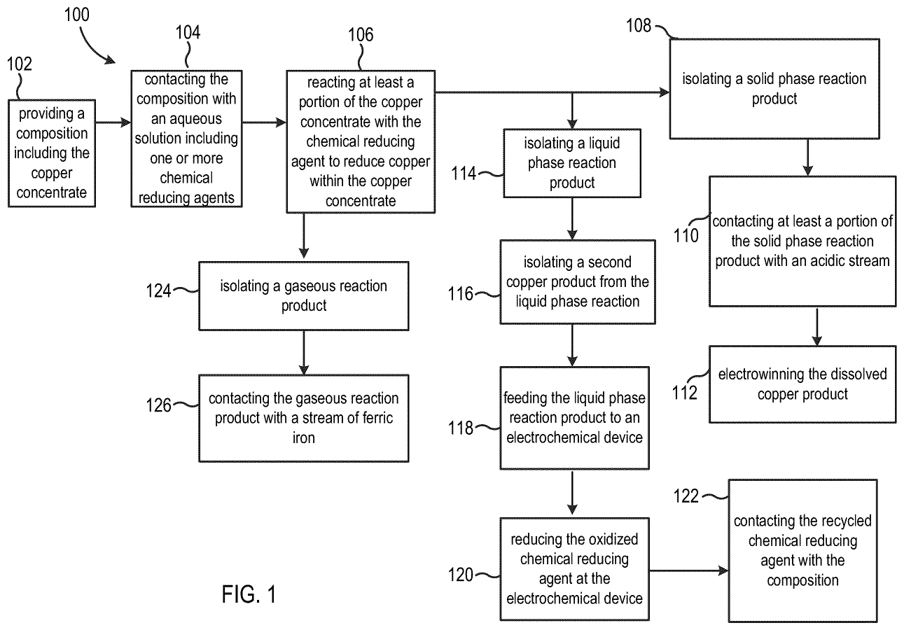

As shown in FIG. 1, it is a schematic structure diagram of a magnetic fluorescent microsphere in one embodiment. The magnetic fluorescent microsphere 10 includes a core 11 composed of a plurality of magnetic nanoparticles 110, a polymer layer 12 coated on the surface of the core 11, quantum dots 13 modified on the surface of the polymer layer 12, and an inorganic layer 14 coated outside the polymer layer 12.

The size of an individual magnetic nanoparticle 110 is generally between 10 and 100 nanometers, preferably between 20 and 60 nanometers. The core 11 is formed by the aggregation of a plurality of magnetic nanoparticles 110. Due to the presence of magnetic attraction between the plurality of magnetic nanoparticles 110, the stability of their aggregation is high and they are difficult to disperse. The size of the core 11 formed by the aggregation of the plurality of magnetic nanoparticles 110 is about 0.1 to 2 microns, preferably 200 to 500 nanometers. The thickness of the polymer layer 12 further coated outside the core 11 can be 0.1 to 10 microns. Generally, the thickness of the polymer layer 12 is between 0.1 and 0.3 microns. The function of the polymer layer 12 is to coat a plurality of magnetic nanoparticles 110 together. There is not necessarily an obvious boundary between the core 11 and the polymer layer 12. In this embodiment, the core 11 means that a plurality of magnetic nanoparticles 110 is taken as the center, or that the polymer layer 12 coats the aggregates of the plurality of magnetic nanoparticles 110 inside therein. The method for coating the polymer layer 12 on the core 11 includes the microemulsion method. Specifically, the method is as follows: preparing the water-in-oil microemulsion, wherein the water contains a plurality of magnetic nanoparticles 110, and the oil contains the precursor of the polymer layer 12. The core 11 of the magnetic fluorescent microsphere 10 and the polymer layer 12 above can be obtained through the microemulsion polymerization.

The polymer layer 12 is preferably a polyethylene-based material, such as polystyrene. The method for modifying quantum dots on the surface of the polymer layer 12 includes generating intermolecular force or preparing chemical bonds between the polymer layer 12 and the quantum dots 13. For example, when the surface of the polymer layer 12 contains groups that can react with the surface groups of the quantum dots 13, such as amino group and carboxyl group, they can react only by simple mixing in the solution, or there is a strong intermolecular force between the surface group of the quantum dots 13 and the surface of the polymer layer 12, such as hydrogen bond.

The outer surface of the polymer layer 12 is also coated with an inorganic layer 14, and the thickness of the inorganic layer 14 is preferably 0.1 to 10 microns, more preferably 0.1 to 1 microns. The function of the inorganic layer 14 is to protect the materials such as quantum dots, etc. and reduce the damage caused by the external environment. The materials that can be used as inorganic layer 14 include but are not limited to silicon-containing oxide, aluminium-containing oxide, zirconium-containing oxide, glass, titanium-containing oxide, hafnium-containing oxide or yttrium-containing oxide, etc. Specifically, it can be silica, etc.

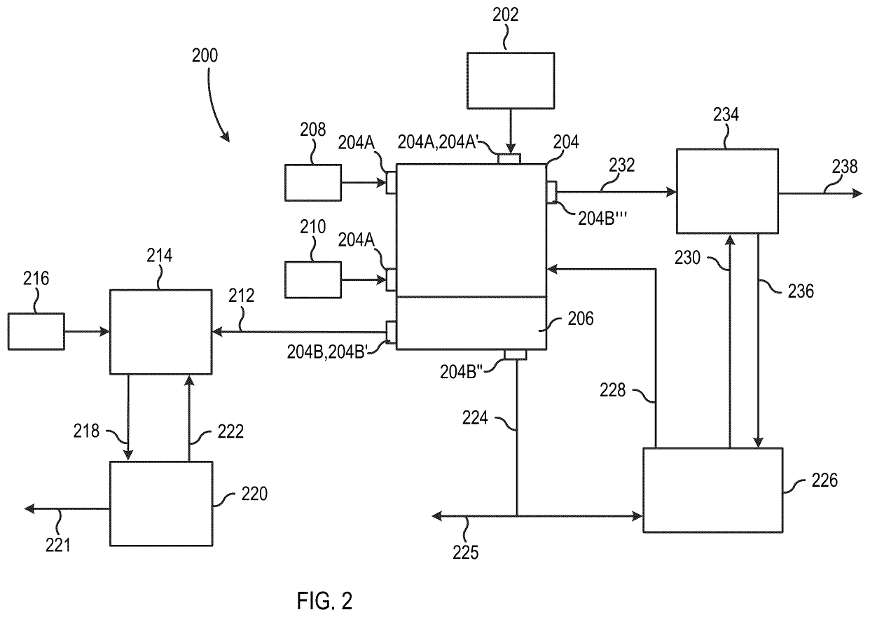

As shown in FIG. 2, it is a schematic structure diagram of a magnetic fluorescent microsphere. The magnetic fluorescent microsphere 20 includes a core 21 of a mesoporous microsphere with a pore 211, and the magnetic nanoparticles 22 and the quantum dots 23 are filled in the pore 211 of the core 21; and an inorganic layer 24 coated on the surface of the core 21. Mesoporous microspheres include but are not limited to polymer microspheres or inorganic microspheres containing pores. For example, porous inorganic microspheres can be porous silica, porous alumina, porous glass, porous zirconia and porous titanium dioxide, in which the average size range of the pore 211 is 0.1 to 10 microns. The materials that can be used as inorganic layer 24 include but are not limited to silicon-containing oxide, aluminium-containing oxide, zirconium-containing oxide, glass, titanium-containing oxide, hafnium-containing oxide or yttrium-containing oxide, etc. The inorganic layer 24 preferably has high mutual cohesiveness with the mesoporous microspheres, that is to ensure that the inorganic layer 24 can be effectively coated on the surface of the mesoporous microspheres. For example, the mesoporous microspheres can be mesoporous silica microspheres, and the inorganic layer can be a silica layer.

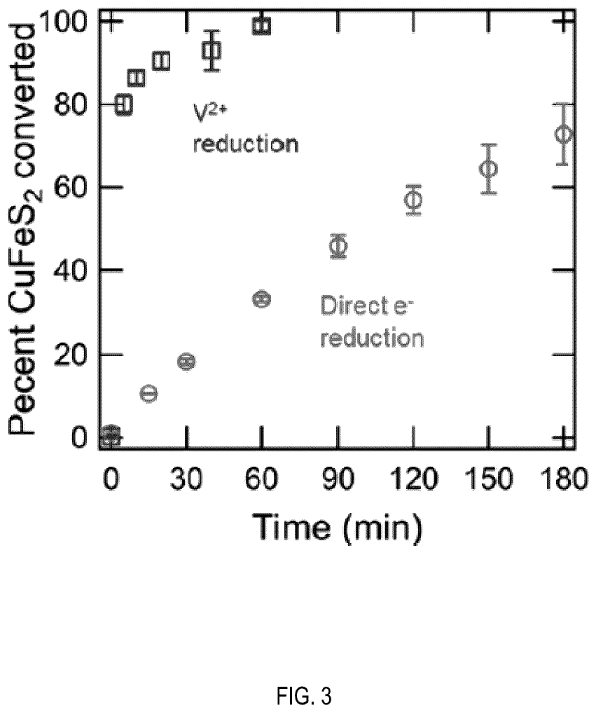

As shown in FIG. 3, it is a schematic structure diagram of a magnetic fluorescent microsphere. The magnetic fluorescent microsphere 30 includes a core 31 containing a plurality of magnetic nanoparticles 310 and quantum dots 33, and an inorganic layer 34 coated on the surface of the core 31.

In the present embodiment, the inorganic layer 34 is used to coat a plurality of magnetic nanoparticles 110 and quantum dots 33 together, not only acts as a carrier but also a protective material for both. The method for coating the inorganic layer 34 on the core 31 includes the microemulsion method. Specifically, the method is as follows: preparing the water-in-oil microemulsion, wherein the water contains a plurality of magnetic nanoparticles 310 and quantum dots 33, and the oil contains the precursor of the inorganic layer 34, and the above magnetic fluorescent microsphere 30 can be obtained through the microemulsion polymerization. For example, when the inorganic layer 34 is a silica layer, the precursor of the inorganic layer 34 may be a silicate compound.

It should be noted that in the above magnetic fluorescent microspheres of the embodiments as shown in FIG. 1, FIG. 2 and FIG. 3, the quantum dots 33 can be replaced by other fluorescent materials, such as fluorescent organic molecules.

In an embodiment of the present application, the polymer of the magnetic fluorescent microsphere includes magnetic nanoparticles and a polymer. The polymer can emit fluorescence and contains fluorescence-emitting functional groups. In this case, the magnetism of the magnetic fluorescent microspheres originates from magnetic nanoparticles, while the fluorescence of the magnetic fluorescent microspheres originates from the polymer. In this way, no other fluorescent substances can be added to the magnetic fluorescent microspheres.

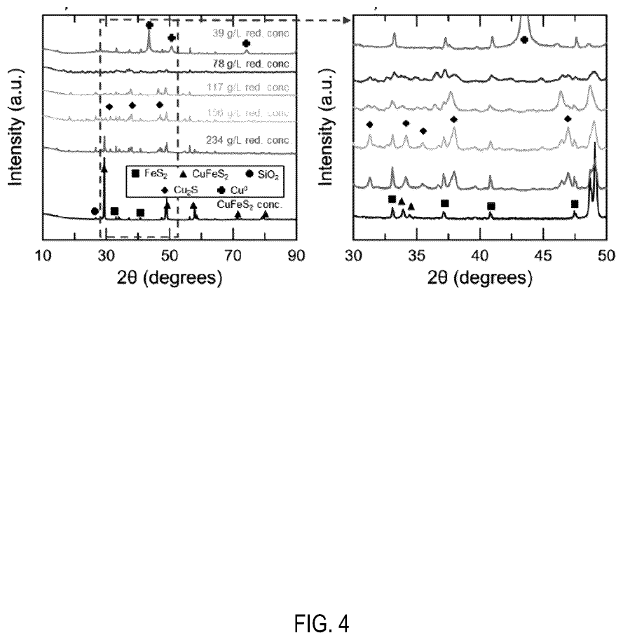

As shown in FIG. 4, it is a schematic structure diagram of a magnetic fluorescent microsphere.

The magnetic fluorescent microsphere 40 includes a core 41 containing a plurality of magnetic nanoparticles 410 and a polymer layer 42 coated on the surface of the core 41. The polymer layer 42 can emit fluorescence, that is, the fluorescence originates from the structure of the polymer layer 42 itself. The method for coating the polymer layer 42 on the core 41 includes the microemulsion method. Specifically, the method is as follows: preparing the water-in-oil microemulsion, wherein the water contains a plurality of magnetic nanoparticles 410, and the oil contains the precursor of the polymer layer 42. The core 41 of the magnetic fluorescent microsphere 40 and the polymer layer 42 above can be obtained through the microemulsion polymerization.

In the polymer with fluorescence, there are functional groups that can emit fluorescence in the polymer structure, and the common fluorescence-emitting group includes but is not limited to stilbenes, coumarins, fluoranes (xanthenes), benzoxazoles (including imidazoles and thiazoles), naphthalimides, thiophene dicarboxylic acid amides, fused-ring aromatics (fluoranthene), perylene tetraformylimines, etc. In one embodiment, monomers for synthesizing the polymers with fluorescence include: fluorescein isothiocyanate, tetramethylisothiocyano rhodamine, heme, rhodamine B, 5 (6)-carboxytetramethylrhodamine, rhodamine 6G, rhodamine 123, rhodamine 101, fluorescein, Hoechst fluorescent dye, 4′,6-diamidino-2-phenylindole, copper phthalocyanine disulfonic acid, dihydroxysilicon phthalocyanine, and scarlet acid, etc., containing reactive groups such as amino, hydroxyl, sulfhydryl, carboxyl, sulfo, isothiocyano, acid chloride group, sulfonyl chloride group, and epoxide group, etc. These monomers are polymerized with each other or polymerized with other monomers without fluorescence, so as to prepare a polymer with fluorescence.

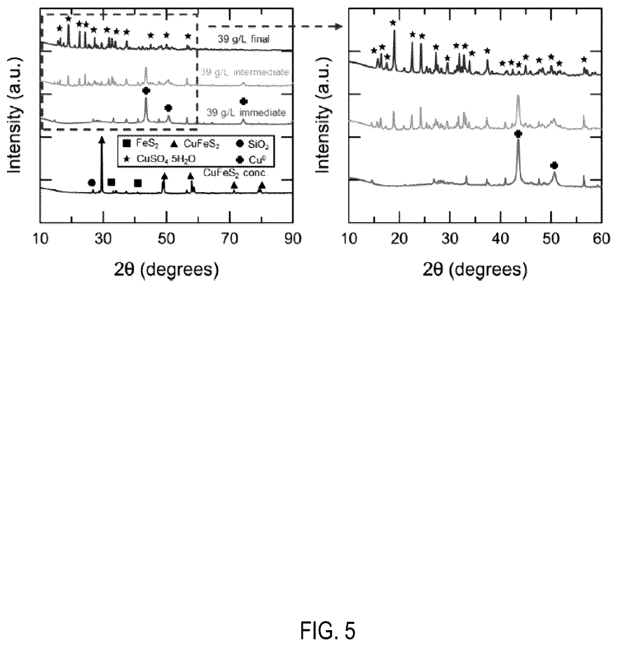

As shown in FIG. 5, it is a schematic structure diagram of the magnetic fluorescent microsphere in one embodiment, the core of the magnetic fluorescent microsphere 50 composed of quantum dots 51, and the magnetic material layer 52 coated on the surface of the quantum dots 51. The surface of the magnetic material layer can be further coated with protective materials such as polymers or inorganics. In one embodiment, as shown in FIG. 5, an inorganic layer 53 is coated on the magnetic material layer 52. The size of the quantum dot 51 is preferably between 1 and 20 nm, the thickness of the magnetic material layer 52 is preferably between 1 and 50 nm, and the thickness of the inorganic layer 53 is preferably between 10 and 100 nm.

The materials of which the quantum dots are constituted generally include Group IIB-VIA, Group IIIA-VA, Group IVA-VIA, Group IVA, Group IB-IIIA-VIA, Group VIII-VIA, and perovskite materials, etc. These materials refer to the luminescent center of the quantum dots, which specifically can be ZnO, ZnS, ZnSe, ZnTe, CdS, CdSe, CdTe, MgS, MgSe, GaAs, GaN, GaP, GaSe, GaSb, HgO, HgS, HgSe, HgTe, InAs, InN, InP, InGaP, InSb, AlAs, AlN, AlP, AlSb, TlN, TlP, TlAs, TlSb, PbS, PbSe, PbTe, Si, C, etc., and an alloy comprising any of the foregoing substances and/or a mixture comprising any of the foregoing substances, including a ternary and quaternary mixture or an alloy. Quantum dots generally include core and shell, the core includes a first semiconductor material, and the shell includes a second semiconductor material, wherein the shell is arranged on at least a part of the surface of the core. Semiconductor nanocrystals including core and shell are also called “core/shell” quantum dots. Any of the materials indicated above can be particularly used as core.

The magnetic material layer of the magnetic material layer 52 includes, but is not limited to, metals and metal oxides having superparamagnetism, paramagnetism or ferromagnetism, for example, Fe₃O₄, Fe₂O₃, CoFe₂O₄, MnFe₂O₄, NiFe₂O₄, compound neodymium iron boron, samarium cobalt, metals Fe, Co, Ni or metal oxides of alloys Fe₂Co. Ni₂Fe, etc.

In one embodiment, the structure of the magnetic fluorescent microspheres is C-QD/Fe₃O₄, that is, the core is carbon quantum dots (C-QDs), and the surface of the carbon quantum dots is coated with the shell of Fe₃O₄; or C-QD/Fe₃O₄/SiO₂, that is, the core is the carbon quantum dots (C-QDs), and the surface of the carbon quantum dots is coated with the shell of Fe₃O₄ and then further coated with a SiO₂ layer; or C-QD/Fe₃O₄/Ps/SiO₂, that is, the core is the carbon quantum dots (C-QDs), and the surface of the carbon quantum dots is coated with the shell of Fe₃O₄, and then further coated with a PS layer (polystyrene) and a SiO₂ layer. The core of the above carbon quantum dots can be replaced with CdSe quantum dots and InP quantum dots.

In one embodiment, a proppant composition for hydraulic fracturing is disclosed, including proppant particulates and magnetic fluorescent microspheres. Proppant particulates and magnetic fluorescent microspheres are combined together and used as a composition, the method for combining the above two includes: physical force between the two, or coating the two in the same carrier, etc.

In a cased borehole in a vertical well, for example, high-pressure fluid flows out of the borehole through the casing and the surrounding cement via a perforation and causes fracturing of the hydrocarbon reservoir. The role of the proppant is to prevent the fracture from being completely closed, so that it can provide a high conductivity flow path for the wellhole. Proppant can be composed of sand, resin coated sand or ceramic particles, or of organic compound microspheres or inorganic microspheres. When the oil field tracer is combined with the hydraulic fracturing, there is a weak interaction between the magnetic fluorescent microspheres and the proppant. When the proppant is filled in the fracture, the magnetic fluorescent microspheres are separated from the proppant at a slow speed, thereby prolonging the release time of the tracer.

In an exemplary embodiment, the method for hydraulic fracturing tracing includes injecting hydraulic fluid into the formation at a rate and pressure sufficient to open the fracture therein, injecting the proppant composition into the formation, separating the magnetic fluorescent microspheres from the proppant, slowly releasing, and then returning the magnetic fluorescent microspheres and the generated fluid to the surface, and performing magnetic field enrichment and reanalysis treatment thereto.

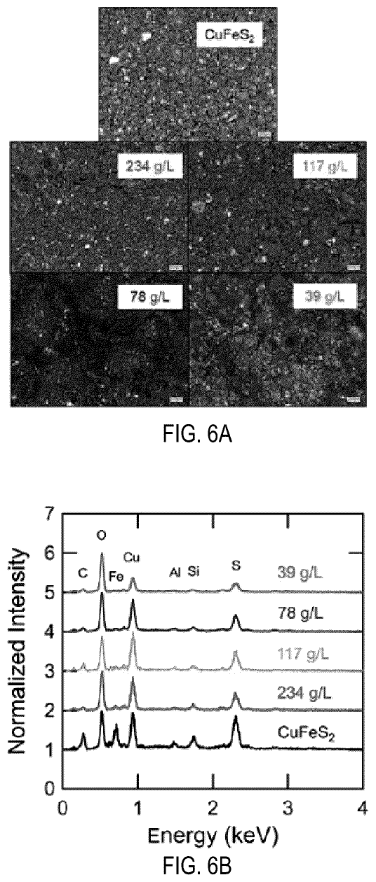

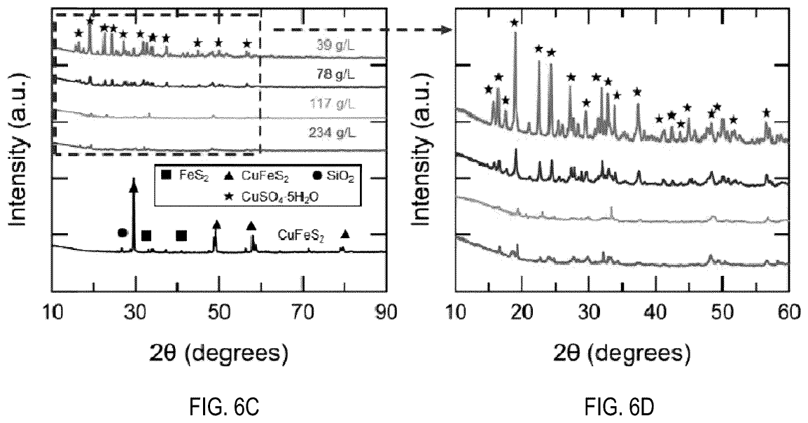

As shown in FIG. 6, it is the schematic diagram of the application of the magnetic fluorescent microspheres in the oil field tracing. In FIG. 6, 61 is an injection well. After the proppant composition, high-pressure water and other reagents, etc. are injected into the injection well 61, the high-pressure water impacts the rock 63 to produce the fracture 64, and the proppant composition is filled in the fracture 64 to prevent the fracture 64 from closing again. The arrow in the Figure represents the flow direction of the fluid, which includes water, oil or generally a mixture of both. With the injection of high-pressure water and the flow of the fluid, the magnetic fluorescent microspheres 66 combined with the proppant 65 slowly separate from the proppant 65, so that the magnetic fluorescent microspheres 66 can be collected when sampling in the withdrawal well 62. Thus, the whole collection process of the tracer is completed.

The weak interaction between the magnetic fluorescent microspheres and the proppant can be realized by the following ways: for example, the magnetic fluorescent microspheres and the proppant can be simply aggregated by intermolecular force, or the magnetic fluorescent microspheres can be encapsulated in the micropores of the proppant by using a proppant with microporous structure, and then they are released gradually. The controlled slow release of the tracer can depend on the surface charge between the tracer and the proppant, which in turn can depend on the adsorption/desorption performance of the tracer for the adsorbent, pH change, salinity, hydrocarbon composition, temperature and pressure, etc.

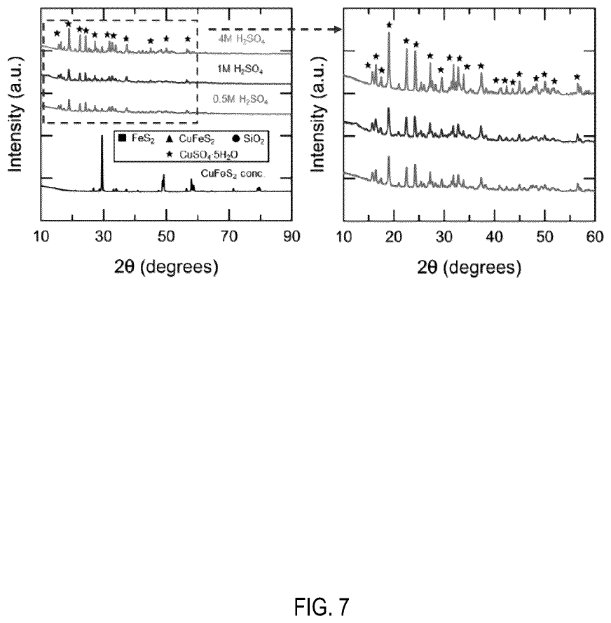

In one embodiment, the proppant particulates can preferably be porous proppant. The internal pores in the porous proppant can be used for tracer injection, so that the porous proppant acts as the carrier of the tracer in the hydraulic fracturing operation. As shown in FIG. 7, the magnetic fluorescent microspheres 71 are arranged in the pore 721 of the porous proppant 72. In order to slow down the release of magnetic fluorescent microspheres, the pore 721 of the porous proppant 72 can be encapsulated with coating. The coating may be or includes one or more organic or inorganic materials. For example, the coating may be or includes a polymer material. The magnetic fluorescent microspheres 71 located in the internal pores of the proppant particulates 72 gather together, and there can be a weak interaction force between them and the internal pores 721 of the proppant particulates 72. The magnetic fluorescent microspheres 71 can slowly flow out of the internal pores 721 of the porous proppant 72, so as to maintain the effect of tracing for a long time, and there is no need to continuously inject tracers into the oil field.

In one embodiment, magnetic fluorescent microspheres and the proppant are aggregated by intermolecular force. For example, in some cases, they can be agglomerated by directly mixing the two in the same solution.

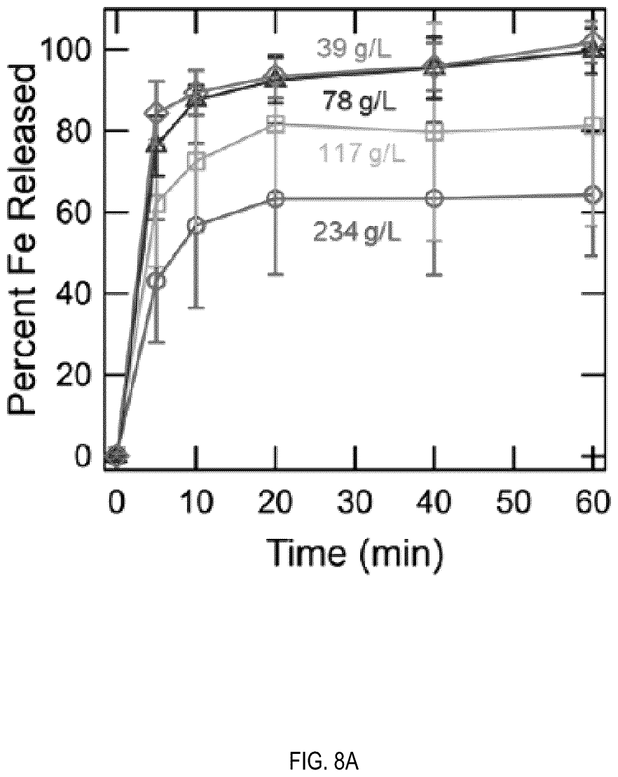

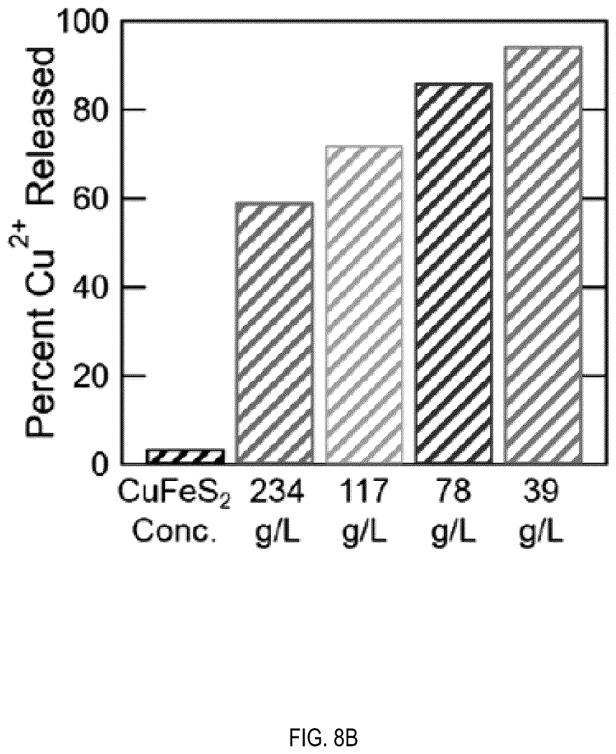

As another example, the magnetic fluorescent microspheres and the proppant particulates can be connected together through a binder such as a resin binder or a tackifying resin. In one embodiment, as shown in FIG. 8, both the magnetic fluorescent microspheres 81 and the proppant particulates 82 can be dispersed in the binder 83 with the binder 83 as the carrier. In the composition, the acting force between the magnetic fluorescent microspheres 81, the proppant particulates 82 and the binder 83 is preferably intermolecular force. The magnetic fluorescent microspheres 81 can be slowly separated from the binder 83, so as to maintain the effect of tracing for a long time without continuously injecting tracers into the oil field. The binder 83 is generally a polymer material, such as acrylic resin, epoxy resin, and cellulose, etc.

In one embodiment of the present application, there is provided a method for oil field tracing, including the following steps: injecting a fluid including an oil field tracer into an injection well, wherein the oil field tracer has magnetism and fluorescence; obtaining the sample to be tested at the withdrawal well; and analyzing the sample to be tested so as to determine whether the oil field tracer is present therein. In one embodiment, the step for analyzing the samples to be tested includes the processes of magnetic enrichment and fluorescence detection of the oil field tracer.

The fluid injected into the injection well is generally water. The components of the sample to be tested obtained from the withdrawal well can be crude oil, water, or a mixture of crude oil and water.

In one embodiment, the method for oil field tracing includes the processes of magnetic enrichment and fluorescence detection of the oil field tracer. In the process of magnetic enrichment, the oil field tracers in the sample to be tested will gather together under the action of magnetic field. Then, after the magnetic enrichment, fluorescence detection is carried out for these enriched oil field tracers. Since the concentration of the oil field tracers in the samples to be tested may be too low to be detected by fluorescence detection instruments, the process of magnetic enrichment can effectively enrich the oil field tracers together, and then it will be much easier to detect their fluorescence. In this way, it is easier to determine whether there is an oil field tracer in the sample to be tested when using an oil field tracer with magnetism and fluorescence.

Some exemplary embodiments according to the present application will be described in more detail below with reference to various embodiments. However, the exemplary embodiments of the present application are not limited thereto.

Example 1 provides a magnetic fluorescent microsphere. Magnetic nanoparticles were encapsulated in a polymer, quantum dots were modified on the polymer and coated layer by layer. The magnetic fluorescent microspheres were prepared as follows:
preparation of Fe₃O₄ magnetic nanoparticles: taking a 500 ml three-necked flask, dissolving 15 g of hydrated ferric chloride and 7 g of hydrated ferrous chloride in 80 ml of distilled water by coprecipitation method, heating to 60° C., and adding 60 ml (a mass fraction: 25% to 28%) of concentrated ammonia into the three-necked flask at 1500 r/min for reacting 15 minutes; then further adding 9 ml of oleic acid into the three-necked flask, adjusting the temperature to 80° C. and reacting for 40 minutes, then cooling to room temperature after the reaction was completed,
washing with ethanol for multiple times, separating and extracting with a magnetic separator, and dispersing in 40 ml of styrene for ready use.

Coating polystyrene (PS) layer on Fe₃O₄ magnetic nanoparticles (Fe₃O₄/Ps magnetic microspheres): taking a 500 ml three-necked flask, dissolving 0.3 g of lauroyl peroxide (LPO) in 15 ml of styrene, adding 4 ml of methyl acrylate (MA) and 0.45 ml of divinylbenzene (DVB), then further adding 45 ml of 1% polyvinyl alcohol aqueous solution and 125 ml of ultrapure water, dispersing at high speed for 30 minutes at a rotating speed of 3000 r/min, introducing nitrogen after the dispersion was completed, and then reducing the rotating speed to 450 r/min under the condition of heating to 75° C. in a nitrogen atmosphere, the final emulsion being brown after reacting for 4-7 hours, washing with ethanol for multiple times, and separating and collecting by magnetic separator for ready use; dispersing the collected Fe₃O₄/Ps magnetic microspheres in 40 ml of 1% polyacrylic acid (PAA) aqueous solution, adjusting the rotating speed to 500 r/min, heating at a constant temperature of 75° C. for 30 minutes, cooling to room temperature, separating with this separator, collecting and dispersing in 40 ml of ethanol for ready use.

Modification of quantum dots on Fe₃O₄/Ps spheres and coating of inorganic layer (Fe₃O₄/Ps/CdSe-QDs@SiO₂): diluting 0.5 ml of 1% red light CdSe-QDs (QY=77%) solution to ten-fold, dispersing it in the mixed solution of V ethanol:V chloroform=1:15, then diluting 0.5 ml of the prepared magnetic microspheres to ten-fold, dispersing it in 5 ml of V ethanol:V chloroform=1:15 after magnetic separation, homogenizing the mixed solution on a vortex homogenizer for 5 to 8 minutes, washing it three times with ethanol after magnetic separation, then dispersing the obtained magnetic fluorescent microspheres in 5 ml of aqueous solution for ready use; coating the fluorescent magnetic spheres with silica by Stober method: dispersing the obtained solution in a mixed solution of 65 ml of absolute ethanol, 20 ml of ultrapure water and 1 ml of concentrated ammonia after magnetic separation, dropwise adding 0.3 to 0.6 mL of tetraethyl orthosilicate (TEOS) at a constant temperature of 35° C. and a rotating speed of 600 r/min and continuously reacting for 2 to 6 hours (according to the requirements of thickness), finally washing after magnetic separation and storing in ethanol solution to obtain the magnetic fluorescent microspheres. The mass ratio of magnetic material to fluorescent material in the magnetic fluorescent microspheres was determined to be 5:1 by ICP-MS.

Example 2 provides a magnetic fluorescent microsphere. The preparation method was basically the same as that of Example 1, except that 0.2 ml of the prepared magnetic microsphere was diluted to ten-fold. The mass ratio of magnetic material to fluorescent material in the magnetic fluorescent microspheres was determined to be 2:1 by ICP-MS.

Example 3 provides a magnetic fluorescent microsphere. The preparation method was basically the same as that of Example 1, except that 0.4 ml of the prepared magnetic microsphere was diluted to ten-fold. The mass ratio of magnetic material to fluorescent material in the magnetic fluorescent microspheres was determined to be 4:1 by ICP-MS.

Example 4 provides a magnetic fluorescent microsphere. The preparation method was basically the same as that of Example 1, except that 0.6 ml of the prepared magnetic microsphere was diluted to ten-fold. The mass ratio of magnetic material to fluorescent material in the magnetic fluorescent microspheres was determined to be 6:1 by ICP-MS.

Example 5 provides a magnetic fluorescent microsphere. The preparation method was basically the same as that of Example 1, except that 1.0 ml of the prepared magnetic microsphere was diluted to ten-fold. The mass ratio of magnetic material to fluorescent material in the magnetic fluorescent microspheres was determined to be 10:1 by ICP-MS.

Example 6 provides a magnetic fluorescent microsphere, quantum dots and magnetic nanoparticles in the swelling pores of the polymer, and the preparation method is as follows,

The system was calculated according to 100 parts: dissolving 5 parts of sodium hydroxide in water, and adding 25 parts of methacrylic acid for pretreatment; then successively adding 3 parts of acrylamide, 5 parts of hydroxyethyl acrylate and 1 part of N,N′-methylene bisacrylamide, stirring evenly, the balance being deionized water, heating to 60° C. for thermostatic reaction, adding 5 parts of magnetic nano materials and 1 part of red light CdSe-QDs solution (QY=77%), and then adding 1 part of initiator (ammonium persulfate) for free radical polymerization; finally, oven-drying the reaction product at a constant temperature.

Example 7 provides a magnetic fluorescent microsphere in which the quantum dots and magnetic nanoparticles were embedded in a polymer; the preparation method is as follows, Taking a 500 ml three-necked bottle, dissolving 0.3 g of lauroyl peroxide (LPO) in 15 ml of 1% Fe₃O₄ styrene, adding 4 ml of methyl acrylate (MA) and 0.45 ml of divinylbenzene (DVB), and 3 ml of 1% red light CdSe-QDs solution (QY=77%), then further adding 45 ml of 1% polyvinyl alcohol aqueous solution and 125 ml of ultrapure water, dispersing at high speed for 30 minutes at a rotating speed of 3000 r/min, introducing nitrogen after the dispersion was completed, and then reducing the rotating speed to 450 r/min under the condition of heating to 75° C. in a nitrogen atmosphere, the final emulsion being brown after reacting for 4-7 hours, washing with ethanol for multiple times, and separating and collecting by magnetic separator.

Example 8 provides a magnetic fluorescent microsphere, in which the quantum dots were modified on inorganics coated with magnetic nanoparticles and bonded by functional groups; the preparation method thereof is as follows,

Coating the magnetic spheres with silica by Stober method: dispersing the above obtained Fe₃O₄ material in a mixed solution of 65 ml of absolute ethanol, 20 ml of ultrapure water and 1 ml of concentrated ammonia after magnetic separation, dropwise adding 0.3 to 0.6 mL of tetraethyl orthosilicate (TEOS) and 1 ml of APTES at a constant temperature of 35° C. and a rotating speed of 600 r/min and continuously reacting for 2 to 6 hours.

Adding 5 ml of 1% QDs-COOH aqueous solution (QY=77%) to 50 ml three-necked flask, then adding 4 eq. of EDC and 4 eq. of NHS thereto and reacting for 30 minutes, and then adding 15 ml of the above aminated Fe₃O₄@SiO₂ microspheres and reacting for 2 hours, and enriching with a magnetic separator to obtain the magnetic fluorescent microspheres.

Example 9 provides a magnetic fluorescent microsphere, which is basically the same as Example 1, except that the magnetic material was replaced with a more magnetic neodymium iron boron compound.

Example 10 provides a magnetic fluorescent microsphere, which is basically the same as Example 1, except the red light QY=88% of red light CdSe-QDs.

Comparative Example 1 provides a preparation method of conventional fluorescent microspheres, and the specific steps are as follows:

Coating the QDs with silica by Stober method: dispersing the QY=77% of red light CdSe-QDs in a mixed solution of 65 ml of absolute ethanol, 20 ml of ultrapure water and 1 ml of concentrated ammonia, dropwise adding 0.3 to 0.6 mL of tetraethyl orthosilicate (TEOS) at a constant temperature of 35° C. and a rotating speed of 600 r/min and continuously reacting for 2 to 6 hours.

TABLE 1:1
Performance characterization of magnetic fluorescent
microspheres prepared in Examples 1-10 and Comparative
Example1, in which the detection limit is the minimum
amount of magnetic fluorescent microspheres required
to detect the substance to be tested, and QY is the
quantum efficiency of magnetic fluorescent microspheres.

| | Detection limit (ppb) | QY (%) |
|---|---|---|
| Example 1 | 3.2 | 70 |
| Example 2 | 252 | 75 |
| Example 3 | 15.3 | 73 |
| Example 4 | 16 | 65 |
| Example 5 | 20 | 35 |
| Example 6 | 9.2 | 68 |
| Example 7 | 15.4 | 65 |
| Example 8 | 6.5 | 73 |
| Example 9 | 3.0 | 69 |
| Example 10 | 1.5 | 83 |
| Comparative | 400.2 | 60 |
| Example 1 | | |

It can be seen from Examples 1-5 that with the gradual increase of the mass ratio of magnetic material to fluorescent material in magnetic fluorescent microspheres, the detection limit of magnetic fluorescent microspheres for crude oil tracing gradually decreases and then gradually increases. The magnetic enrichment effect is better with the increase of the magnetic material, and the fluorescence signal is enhanced with the increase of the fluorescent material, the two play a synergistic and complementary role, and there is a counterbalance between the two. Fe₃O₄ material has a certain absorption of light. When its amount is very high, it will lead to the weak fluorescence signal of the magnetic fluorescent microspheres. Therefore, it is necessary to limit the addition ratio of ferriferrous oxide, and more ferriferrous oxide is not always better, as in Example 5, when the mass ratio of magnetic material to fluorescent material in magnetic fluorescent microspheres is 10:1, although the fluorescence effect of the magnetic fluorescent microspheres is not very high, the magnetic enrichment effect is good, and the fluorescence signal is relatively weak, which can make a counterbalance and can also achieve a better detection effect.

It can be seen from Examples 1 and 6-7 that the different combination methods of magnetic materials and fluorescent materials will also affect the detection effect of the present application. Among them, the combination method of encapsulating the magnetic nanoparticles in the polymer and modifying the quantum dots on the polymer in a layer by layer coating manner is better than the other two methods.

In addition, both Examples 1 and 8 are the method that the magnetic nanoparticles are encapsulated in the polymer and the quantum dots are modified on the polymer. Example 1 adopts the form of layer by layer coating, and Example 8 is the method of functional group bonding. The detection limit of Example 1 is lower than that of Example 8 because the form of layer by layer coating is more stable.

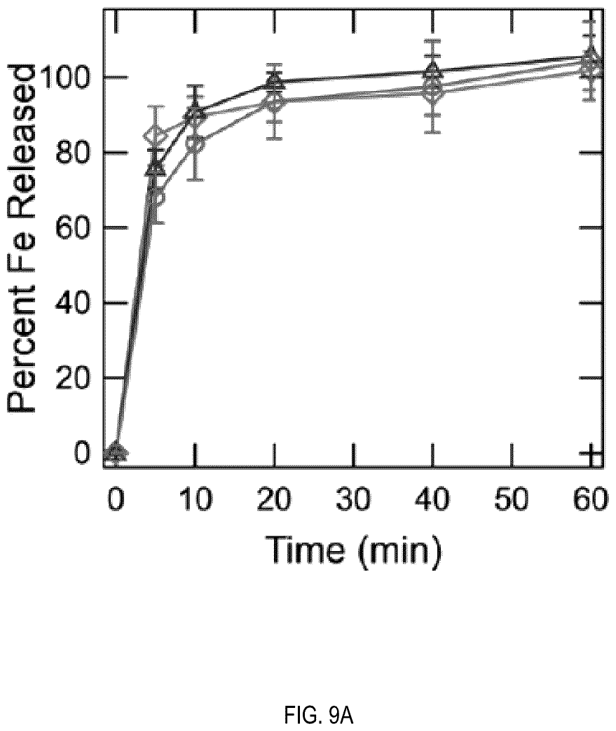

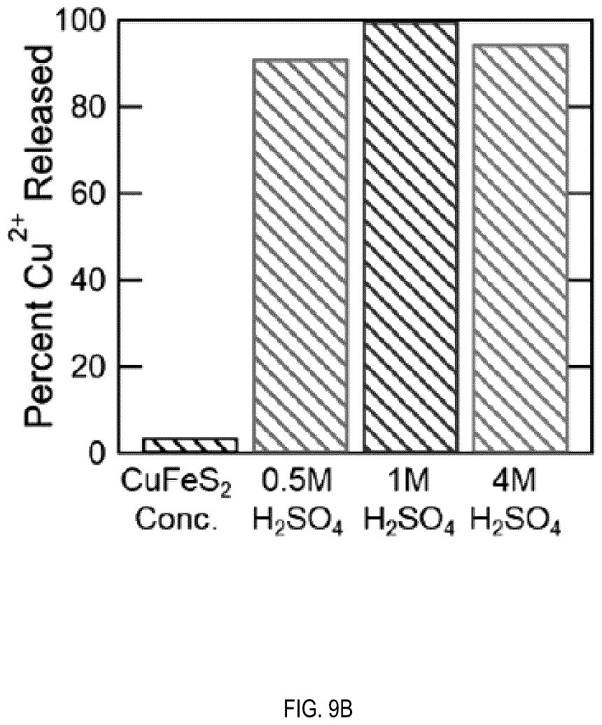

FIG. 9 is a photograph of the ethanol solution of the magnetic fluorescent microspheres prepared in Example 1 in a UV box. The magnetic fluorescent microspheres emit bright red light under the irradiation of UV light. The bright red light originates from the extremely high luminous efficiency of CdSe-QD. Generally, the luminescence quantum efficiency of CdSe-QD is above 85% or even 90%.

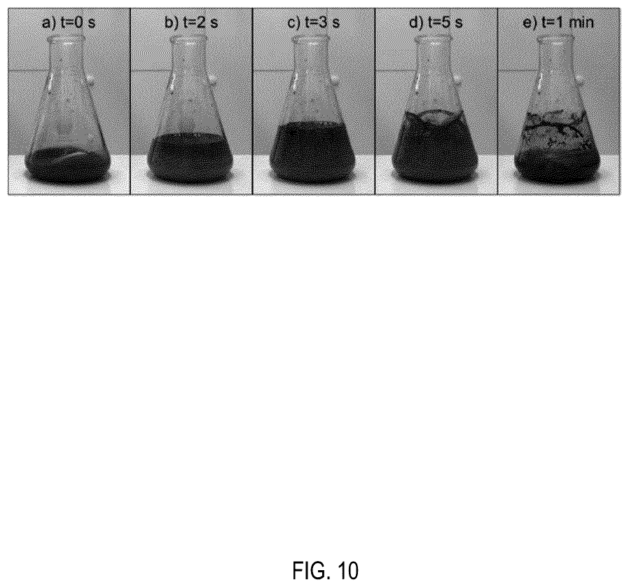

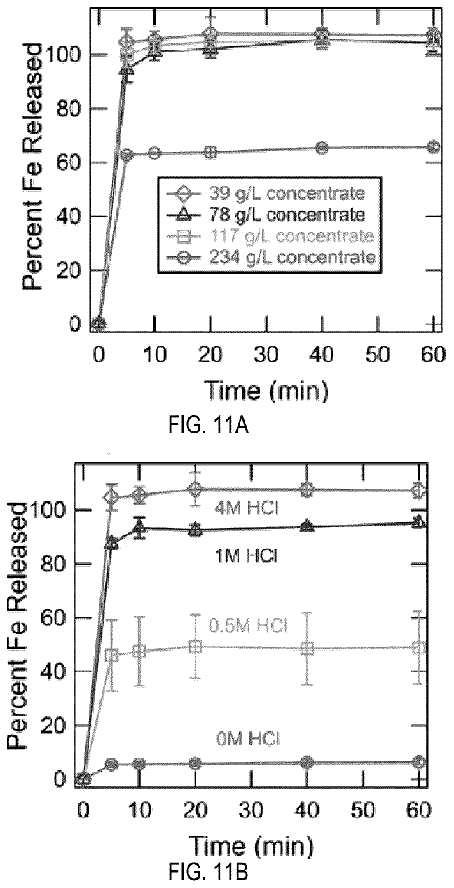

The fluorescence emission spectrum of the magnetic fluorescent microsphere is measured. As shown in FIG. 10, the peak wavelength of the emission peak is at about 630 nanometers, and the half peak width of the emission peak is relatively small (less than 30 nanometers). When the half peak width of the magnetic fluorescent microsphere is smaller, it is more conducive to the identification of the fluorescence emission peak, so as to reduce the interference of other fluorescent substances in the sample to be detected.

The magnetic fluorescent microspheres prepared in Example 1 not only have excellent fluorescence luminescence properties, but also have good magnetic enrichment effect. As shown in FIG. 11, the ethanol solution of the magnetic fluorescent microspheres is placed in the magnetic field, the magnetic fluorescent microspheres are immediately enriched at the magnet. As shown in FIG. 11, the left side shows the enrichment of the magnetic fluorescent microspheres from the front angle, and the right side shows the enrichment of the magnetic fluorescent microspheres from the side angle. It can be seen from the Figure that the magnetic fluorescent microspheres are obviously enriched near the magnet (as shown in the dotted box in the Figure).

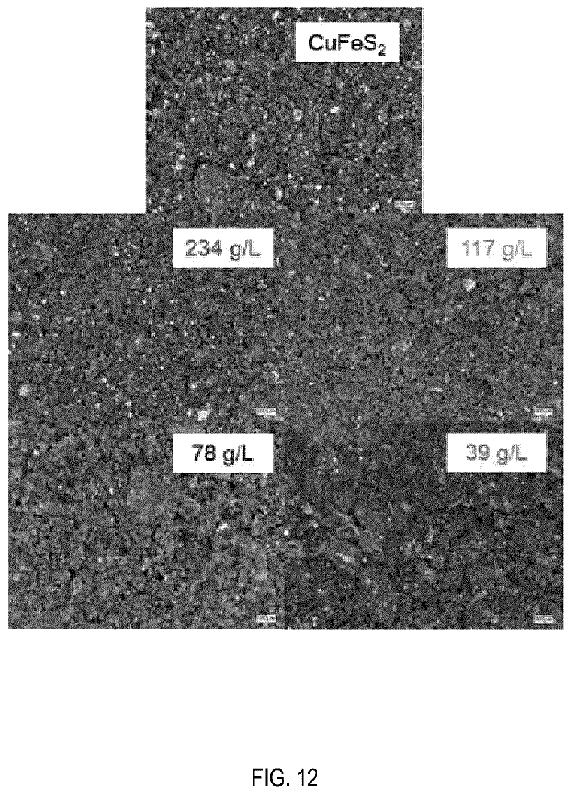

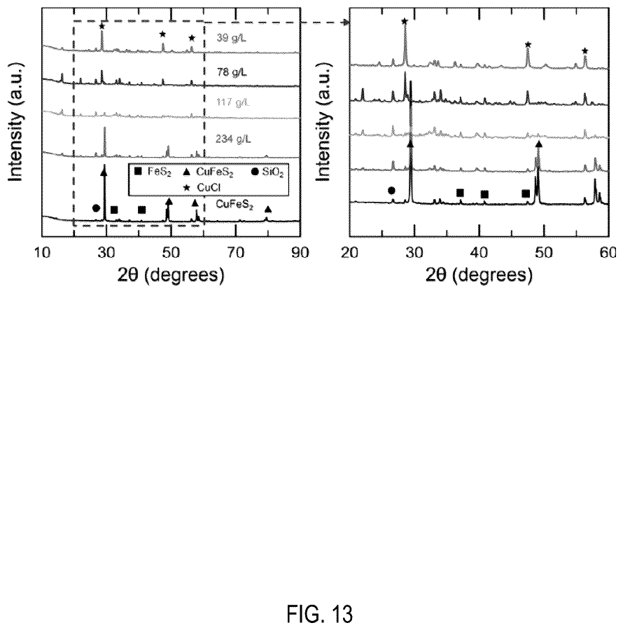

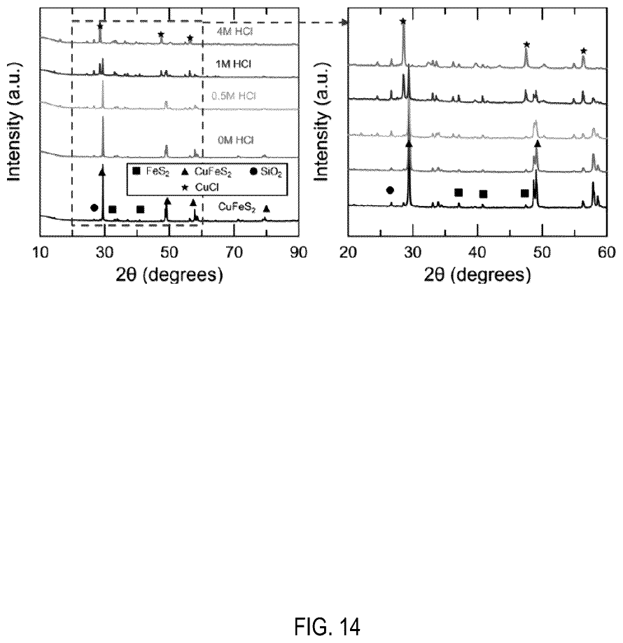

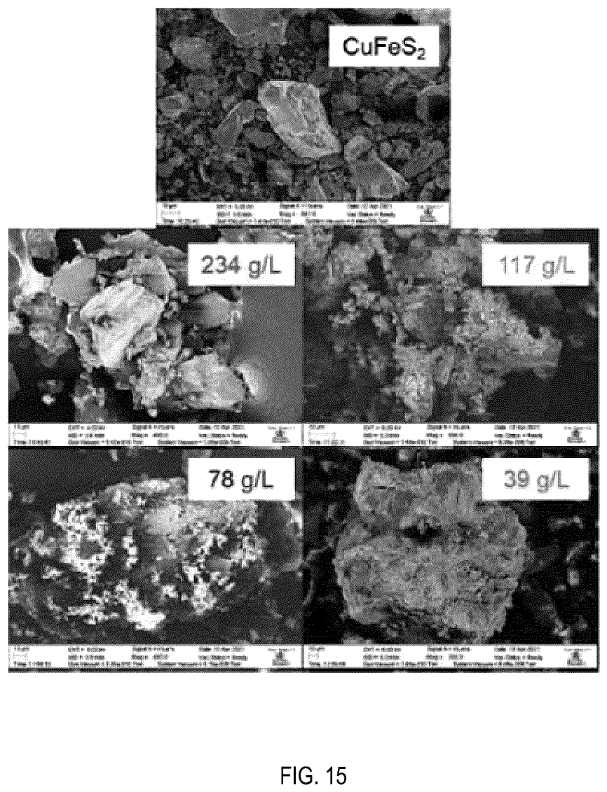

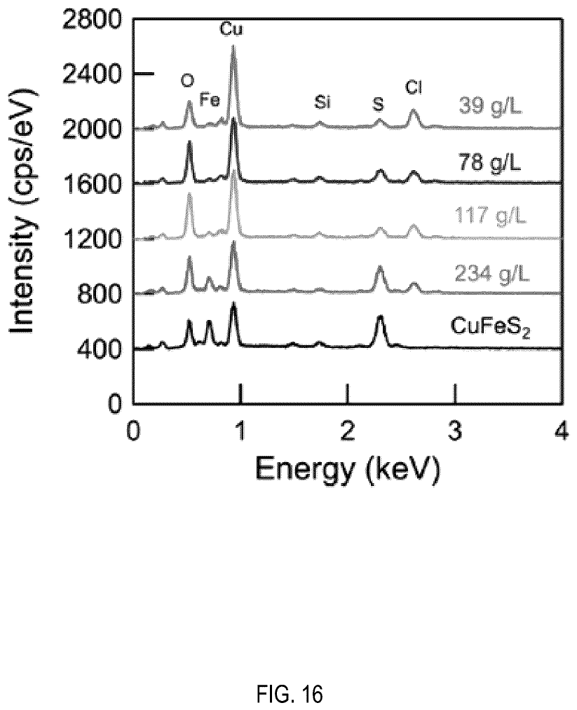

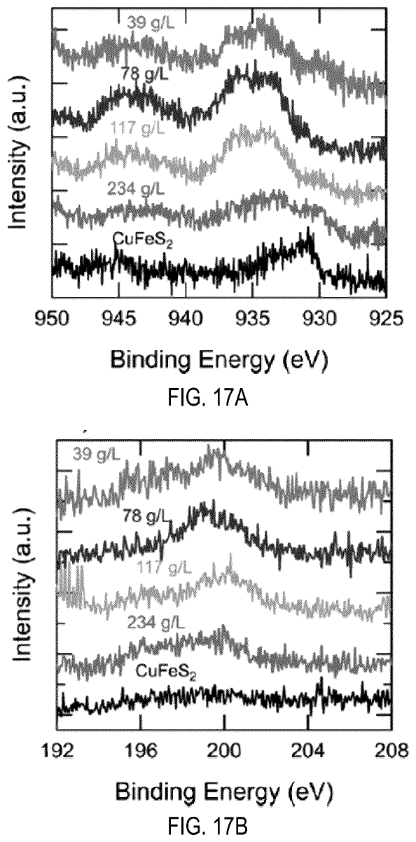

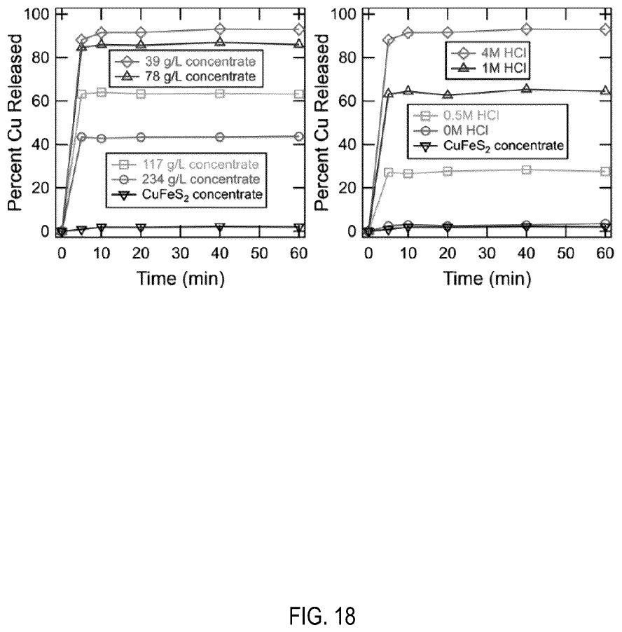

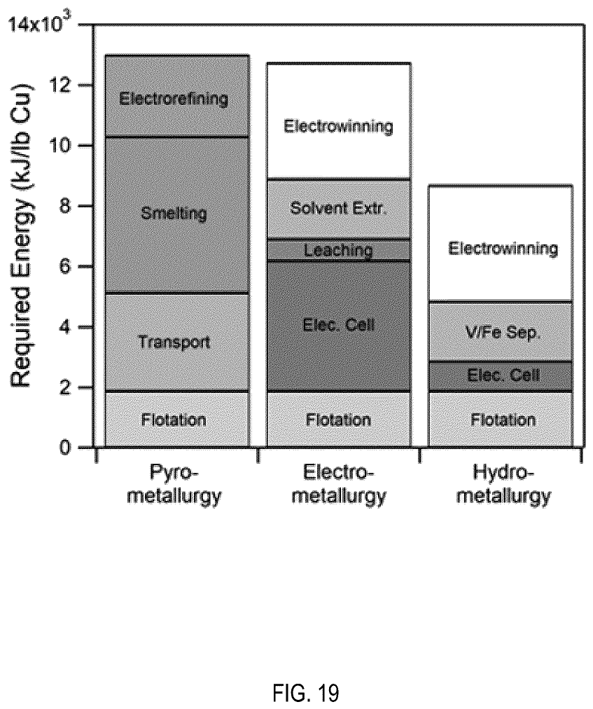

When the magnetic fluorescent microspheres are used as the oil field tracer, when the tracer is oil soluble, the fluorescence emission peaks of the tracer are generally significantly different from those of crude oil in the oil field. For example, FIG. 12 shows the fluorescence emission spectrum of crude oil in a domestic oil field. It can be seen from the Figure that the crude oil contains a large amount of fluorescent substances, and the fluorescence emission peak of the crude oil in the oil field is at about 510 nanometers. The peak wavelength of the emission peak is more than 100 nanometers different from the peak wavelength of the emission peak of the magnetic fluorescent microspheres in Example 1. As shown in FIG. 13, it is a comparison diagram of the fluorescence emission peak of the crude oil and the fluorescence emission peak of the magnetic fluorescent microsphere, with obvious differences therebetween. In addition, due to the great differences in the environment of the oil fields in various regions, the components of the fluorescent substances in crude oil from different oil fields are quite different. When selecting a tracer, the fluorescent emission peaks of the crude oil can be measured in advance, and then the appropriate magnetic fluorescent materials can be selected.

In this application, the oil field tracer with magnetism and fluorescence is constructed. Since the oil field tracer has good magnetic enrichment effect, when it is used as a tracer, the accuracy of tracing in the oil field can be significantly improved.

Although the inventor has described and enumerated the technical solutions of the present application in more detail, it should be understood that it is obvious to those skilled in the art to make modifications and/or changes to the above-mentioned embodiments or to adopt equivalent alternatives without departing from the essence of the spirit of this application, the terms appearing in this application are used for the elaboration and understanding of the technical solutions of this application, and shall not constitute a limitation thereto.

What is claimed is:

1. An oil field tracer, wherein the oil field tracer has magnetism and fluorescence.

2. The oil field tracer according to claim 1, wherein the oil field tracer comprises a magnetic material and a fluorescent material.

3. The oil field tracer according to claim 2, wherein the feeding mass ratio of the magnetic material to the fluorescent material is (2-10):1.

4. The oil field tracer according to claim 3, wherein the feeding mass ratio of the magnetic material to the fluorescent material is (4-6):1.

5. The oil field tracer according to claim 2, wherein the magnetic material comprises: a metal and a metal oxide having superparamagnetism, paramagnetism or ferromagnetism.

6. The oil field tracer according to claim 2, wherein the fluorescent material comprises at least one of fluorescent nanoparticles, fluoresceins, fluorescent polymers or organic fluorescent molecules.

7. The oil field tracer according to claim 6, wherein the fluorescent nanoparticle comprises quantum dots, nanorods or nanosheets.

8. The oil field tracer according to claim 7, wherein the size of the quantum dots is 1 to 20 nanometers.

9. The oil field tracer according to claim 7, wherein the fluorescein comprises stilbenes, coumarins, fluoranes, benzoxazoles, naphthalimides, thiophene dicarboxylic acid amides, fused-ring aromatics, perylene tetraformylimines, phycoerythrin or peridinin chlorophyll proteins.

10. The oil field tracer according to claim 2, wherein the oil field tracer comprises magnetic fluorescent microspheres.

11. The oil field tracer according to claim 10, wherein the magnetic fluorescent microsphere comprises a magnetic material and a fluorescent material.

12. The oil field tracer according to claim 10, wherein the particle size of the magnetic fluorescent microsphere is 0.05-20 microns, preferably 0.05-2 microns.

13. The oil field tracer according to claim 10, wherein the magnetic fluorescent microsphere comprises magnetic nanoparticles, quantum dots and polymers or inorganic substances;
preferably, the polymer is one or more selected from polyethylene, polypropylene, polystyrene, polyoxyethylene, polysiloxane, polyphenylene, polythiophene, poly(phenylene ethylene), polysilane, polyethylene terephthalate and poly (phenylethynyl), polymethylmethacrylate, polylaurylisobutyrate, polycarbonate and epoxy resin;
preferably, the inorganic substance is one or more selected from silicon-containing oxide, aluminium-containing oxide, zirconium-containing oxide, titanium-containing oxide, hafnium-containing oxide or yttrium-containing oxide.

14. The oil field tracer according to claim 13, wherein the quantum dots and the magnetic nanoparticles are embedded in the polymer; or
the quantum dots and the magnetic nanoparticles are in the swelling pores of the polymer; or
the quantum dots and the magnetic nanoparticles are encapsulated in a porous structure of the polymer having a porous structure; or
the quantum dots and the magnetic nanoparticles are modified on the polymer.

15. A method for oil field tracing, wherein it comprises the steps of:
injecting a fluid comprising an oil field tracer according to claim 1 into an injection well, wherein the oil field tracer has magnetism and fluorescence;
obtaining the sample to be tested at the withdrawal well; and
analyzing the sample to be tested so as to determine whether the oil field tracer is present therein.

16. The method according to claim 15, wherein the method further comprises the process of magnetic enrichment and fluorescence detection of the oil field tracer.

17. A proppant composition, wherein it comprises: proppant particulates and the oil field tracer according to claim 1.

18. The oil field tracer according to claim 5, wherein the magnetic material is one or more selected from Fe₃O₄, Fe₂O₃, CoFe₂O₄, MnFe₂O₄, NiFe₂O₄, neodymium iron boron or samarium cobalt.

19. The oil field tracer according to claim 8, wherein the luminescent center of the quantum dots is ZnO, ZnS, ZnSe, ZnTe, CdS, CdSe, CdTe, MgS, MgSe, GaAs, GaN, GaP, GaSe, GaSb, HgO, HgS, HgSe, HgTe, InAs, InN, InP, InGaP, InSb, AlAs, AlN, AlP, AlSb, TlN, TlP, TlAs, TlSb, PbS, PbSe, PbTe, Si or C, or an alloy comprising any of the foregoing substances and/or a mixture comprising any of the foregoing substances.

20. The oil field tracer according to claim 17, wherein the proppant particulates are composed of sand, resin coated sand or ceramic particles.
